(19) United States
(12) Patent Application Publication
(10) Pub. No.: US 2010/0124927 A1
(43) Pub. Date: May 20, 2010

(54) PERIODIC REPORTING FOR INTER-RADIO ACCESS TECHNOLOGY LOCATION-BASED HANDOVERS FROM A GSM MACROCELL TO A WCDMA FEMTOCELL

(76) Inventors: Suat Eskicioglu, Ottawa (CA); Cristian Demetrescu, Maidenhead (GB)

Correspondence Address: MARK W. SINCELL;Williams, Morgan & Amerson, P.C., Suite 1100, 10333 Richmond, Houston, TX, 77042, US

(21) Appl. No.: 12/272,929

(22) Filed: Nov. 18, 2008

(51) Int. Cl. H04W 36/00

(52) U.S. Cl. 455/436

(57) ABSTRACT

The present invention provides a method for implementation in a mobile unit that is configured to communicate with a wireless communication system that includes macrocells and one or more femtocell(s). The macrocells and the femtocells use different radio access technologies. The method includes periodically reporting, from the mobile unit to the macrocell, a distance between said mobile unit and the femtocell and performing an inter-radio access technology handoff of the mobile unit from the macrocell to the femtocell when the distance is less than a threshold distance.

### CROSS REFERENCE TO RELATED APPLICATIONS

This application is related to U.S. patent application Ser. No. 12/265,089, filed on Nov. 5, 2008, entitled “LOCATION-BASED HANDOVERS FROM A MACROCELL TO A FEMTOCELL USING EVENT-TRIGGERED MEASUREMENT REPORT” inventors CRISTIAN DEMETRESCU and SUAT ESKICIOGLU. (2100.043000).

This application is related to U.S. patent application Ser. No. 12/265,136, filed on, Nov. 5, 2008 entitled “LOCATION-BASED HANDOVERS FROM A MACROCELL TO A FEMTOCELL USING PERIODIC MEASUREMENT REPORTING” inventors CRISTIAN DEMETRESCU and SUAT ESKICIOGLU. (2100.043100).

This application is related to U.S. patent application Ser. No. 12/272,911, filed on Nov. 18, 2008, entitled “LOCATION-BASED, EVENT TRIGGERED INTER-RADIO ACCESS TECHNOLOGY HANDOVERS FROM A CDMA MACROCELL TO A WCDMA FEMTOCELL” inventors CRISTIAN DEMETRESCU and SUAT ESKICIOGLU. (2100.043200).

This application is related to U.S. patent application Ser. No. 12/265,173, filed on Nov. 5, 2008, entitled “METHOD FOR ASSOCIATING A CLUSTER OF PREMIER FEMTOCELLS WITH USER EQUIPMENT” inventors CRISTIAN DEMETRESCU and SUAT ESKICIOGLU. (2100.043300).

This application is related to U.S. patent application Ser. No. 12/265,215, filed on Nov. 5, 2008, entitled “METHOD FOR ASSOCIATING A PREMIER FEMTOCELL WITH USER EQUIPMENT” inventors CRISTIAN DEMETRESCU and SUAT ESKICIOGLU. (2100.043400).

### BACKGROUND OF THE INVENTION

1. Field of the Invention

This invention relates generally to communication systems, and, more particularly, to wireless communication systems.

2. Description of the Related Art

Conventional wireless communication systems use a network of base stations to provide wireless connectivity to one or more mobile units. In some cases, the mobile units may initiate wireless communication with one or more base stations in the network, e.g., when the user of the mobile unit would like to initiate a voice or data call. Alternatively, the network may initiate the wireless communication link with the mobile unit. For example, in conventional hierarchical wireless communications, a server transmits voice and/or data destined for a target mobile unit to a central element such as a Base Station Controller (BSC). The BSC may then transmit paging messages to the target mobile unit via one or more base transceiver stations or BTSs. The target mobile unit may establish a wireless link to one or more of the base transceiver stations in response to receiving the page from the wireless communication system. A radio resource management function within the BSC receives the voice and/or data and coordinates the radio and time resources used by the set of base transceiver stations to transmit the information to the target mobile unit. The radio resource management function can perform fine grain control to allocate and release resources for broadcast transmission over a set of base transceiver stations.

A conventional base transceiver station provides wireless connectivity within a geographical region that is referred to as a cell, a macrocell, and/or a sector. Conventional base transceiver stations can transmit signals using a predetermined amount of available transmission power. The range of the macrocell is determined by numerous factors including the available transmission power, angular distribution of the available power, obstructions within the macrocell, environmental conditions, and the like. For example, the range of a macrocell can vary from as little as 300 m in a densely populated urban environment to as much as 10 km in a sparsely populated rural environment. The coverage area can also vary in time if any of these parameters changes.

One alternative to the conventional hierarchical network architecture is a distributed architecture including a network of access points, such as base station routers, which implement distributed communication network functionality. For example, each base station router may combine Radio Network Controller (RNC) and/or PDSN functions in a single entity that manages radio links between one or more mobile units and an outside network, such as the Internet. Base station routers wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies through equivalent Mobile IP signaling. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the separate RNC and PDSN entities in hierarchical networks may be reduced or removed.

At least in part because of the reduced cost and complexity of deploying a base station router, base station routers may be deployed in locations that are impractical for conventional base stations. For example, a base station router may be deployed in a residence or building to provide wireless connectivity to the occupants of the residents of the building. Base station routers deployed in a residence are typically referred to as home base station routers or femtocells because they are intended to provide wireless connectivity to a much smaller area (e.g., a femtocell) that encompasses a residence. Femtocells have a much smaller power output than conventional base stations that are used to provide coverage to macrocells. For example, a typical femtocell has a transmission power on the order of 10 mW. Consequently, the range of a typical femtocell is much smaller than the range of a macrocell. For example, a typical range of a femtocell is about 100 m. Clusters of femtocells may also be deployed to provide coverage to larger areas and/or to more users.

Femtocells are expected to be deployed in conjunction with a macrocellular network in an overlay configuration. For example, a macrocellular network may be used to provide wireless connectivity to a neighborhood that includes numerous residences. Any mobile unit traveling through the neighborhood or located in one of the residences can access the wireless communication system using the macrocellular network. Individual femtocells can be deployed in one or more of the residences to provide overlay coverage within (or near) the residence. Clusters of femtocells can also be deployed in one or more of the buildings to provide overlay coverage within (or near) the building. In either case, there will be a one-to-many relationship between the macrocells and the femtocells within the coverage area. However, mobile unit will typically only be authorized to camp on selected femtocells. For example, mobile unit operated by an individual user can be authorized to camp on femtocells that were installed by the user in their residence. For another example, mobile unit operated by employees can be authorized to camp on femtocells in a femtocell cluster installed by a business.

In many cases, portions of the existing macrocellular network have been in place for a period of time and may therefore be implemented using previous generation radio access technologies. Consequently, the relatively recently installed femtocells may use a more recent generation of radio access technology than the existing macrocells. For example, the wireless communication system may include second-generation macrocells and third generation femtocells. As the user moves throughout the geographic areas served by the macrocells and the femtocells, inter-radio access technology (inter-RAT) hand offs may be needed to handoff the mobile unit between the second-generation (2G) macrocells and the third generation (3G) femtocells. Conventional communication systems use radio conditions and/or the availability of radio resources to determine when to perform an inter-radio access technology hand off. For example, channel qualities and/or signal strengths can be measured using signals transmitted between the mobile unit and the macrocells and/or the femtocells. The conventional system hands off the mobile unit from a macrocell to a femtocell when the channel qualities and/or signal strengths for signals transmitted by the macrocell are poor relative to the measured channel qualities and/or signal strengths for the femtocell.

However, the conventional inter-RAT handoff criteria do not discriminate between generic femtocells, femtocells associated with particular mobile units, and macrocells. Consequently, mobile units may not be handed off to authorized home and/or business femtocells as long as the radio conditions in the macrocellular network are sufficiently high quality, even if the user is inside the home or business covered by the associated femtocell. For example, radio conditions in the macrocellular network may remain sufficiently high quality to prevent substantially all inter-RAT handovers to the femtocell, e.g., when the femtocell is deployed at the center of a macrocell coverage area.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for implementation in a mobile unit that is configured to communicate with a wireless communication system that includes macrocells and one or more femtocell(s). The macrocells and the femtocells use different radio access technologies. The method includes periodically reporting, from the mobile unit to the macrocell, a distance between said mobile unit and the femtocell and performing an inter-radio access technology handoff of the mobile unit from the macrocell to the femtocell when the distance is less than a threshold distance.

In another embodiment, a method is provided for implementation in a wireless communication system that includes one or more macrocells and at least one femtocell. The macrocells and the femtocell use different radio access technologies. The method includes periodically receiving, at the macrocell from the mobile unit, information indicating a distance between the mobile unit and the femtocell and performing an inter-radio access technology handoff of the mobile unit from the macrocell to the femtocell when the distance is less than a threshold distance.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a wireless communication system;

FIG. 2 conceptually illustrates a second exemplary embodiment of a wireless communication system; and

FIG. 3 conceptually illustrates one exemplary embodiment of a method of handing off mobile unit between a macrocell and a femtocell using periodic measurement reporting.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

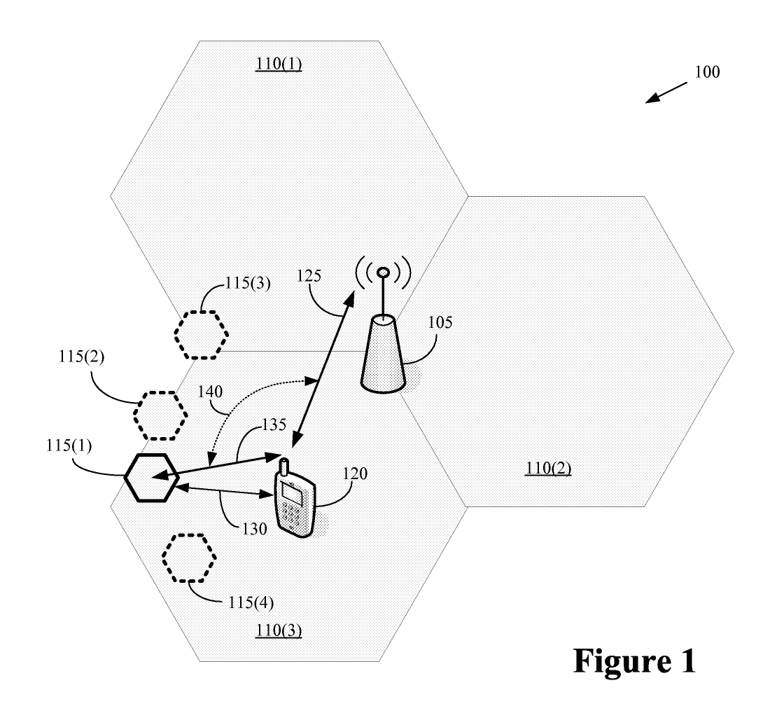

FIG. 1 conceptually illustrates a first exemplary embodiment of a wireless communication system 100. In the illustrated embodiment, a base transceiver station (BTS) 105 provides wireless connectivity to a plurality of macrocells 110(1-3). Although the indices (1-3) can be used to identify individual macrocells 110(1) or subsets thereof, these indices may be dropped when referring collectively to the macrocells 110. This convention may be applied to other elements depicted in the drawings and referred to using an identifying numeral and one or more distinguishing indices. In the illustrated embodiment, the macrocells 110 operate according to Second Generation/ Global System for Mobile communications (2G/GSM) standards and/or protocols. For example, the macrocells 110 can operate according to GSM/GPRS/EDGE, which support the packet-switched (PS) domain of GSM. However, in alternative embodiments the macrocells 110 may operate according to other standards and/or protocols. The macrocells 110 shown in FIG. 1 correspond to different sectors associated with the base transceiver station 105. For example, the base transceiver station 105 may include three antennas (or three groups of antennas) that provide wireless connectivity to three sectors associated with the three macrocells 110. However, persons of ordinary skill in the art having benefit of the present disclosure should appreciate that alternative embodiments may use a different base transceiver station 105 to provide wireless connectivity to each macrocell 110. Moreover, the wireless communication system 100 may include any number of macrocells 110 and/or base transceiver stations 105. In alternative embodiments, the base transceiver stations 105 may be a part of a hierarchical network or a distributed network.

The wireless communication system 100 also includes an overlay network of femtocells 115. For example, the femtocells 115 may be installed in businesses and/or residences by individual users, companies, or other entities. In the interest of clarity, only four femtocells 115 are depicted in FIG. 1. However, persons of ordinary skill in the art having benefit of the present disclosure should appreciate that the wireless communication system 100 may include any number of femtocells 115 distributed throughout the wireless communication system 100. The femtocells 115 operate according to a different radio access technology than the macrocells 110. In the illustrated embodiment, the femtocells 115 operate according to Third Generation standards and/or protocols. However, in alternative embodiments the femtocells 115 may operate according to other standards and/or protocols that differ from the standards and/or protocols used to implement the macrocells 110.

The wireless communication system 100 includes user equipment, such as the mobile unit 120 shown in FIG. 1, that are configured to communicate over the air interface using the standards and/or protocols implemented in both the macrocells 110 and the femtocells 115. The mobile unit 120 can therefore be associated with one or more of the femtocells 115. For example, a user that has installed the femtocell 115(1) in a residence can configure the mobile unit 120 so that the mobile unit 120 recognizes the femtocell 115(1) as its premier femtocell. The mobile unit 120 may therefore preferentially handoff to the premier femtocell 115(1) when the mobile unit 120 approaches the premier femtocell 115(1). In one embodiment, the femtocell 115(1) may be part of a femtocell cluster (not shown in FIG. 1). However, in cases where the femtocell 115(1) and the macrocell 110(3) implement different radio access technologies, an inter-radio access technology (RAT) handover should be used to hand off to the femtocell 115(1) from the base transceiver station 105 that provides connectivity for the macrocell 110(3).

The femtocell 115(1) is a premier femtocell for the mobile unit 120. As used herein, the term “premier femtocell” refers to a femtocell that has been associated with the mobile unit 120 so that the mobile unit 120 is authorized to preferentially access the premier femtocell. Exemplary situations in which a premier femtocell can be defined include femtocells installed by users in their homes, femtocells (or clusters of femtocells) installed in a place of business, and the like. Mobility information related to the premier femtocell 115(1) may be stored in the mobile unit 120 and network entities such as the base transceiver station 105 and/or a base station controller (not shown in FIG. 1) that is communicatively coupled to the base transceiver station 105. Exemplary mobility information includes, but is not limited to, information identifying the premier femtocell 115(1), information indicating a location of the premier femtocell 115(1), information indicating the radio access technology implemented by the premier femtocell 115(1), information indicating a frequency (or frequencies) used by the premier femtocell 115(1) for communication over the air interface, and the like.

In the illustrated embodiment, the mobile unit 120 has an existing wireless communication link 125 with the base transceiver station 105. For example, the mobile unit 120 is in communication with the macrocell 110(3) via one or more antennas supported by the base transceiver station 105 using the link 125 that is established according to 2G/GSM standards and/or protocols. The mobile unit 120 may periodically determine its location and/or measure a distance 130 between the mobile unit 120 and its premier femtocell 115(1). For example, the mobile unit 120 may compare its location to the location of the premier femtocell 115(1) to determine the distance 130. The mobile unit 120 then periodically reports the location information (e.g., its current location and/or the measured distance 130) to the macrocell 110(3). In embodiments that support inter-RAT channel quality measurements, the mobile unit 120 may also perform channel quality measurements, e.g., using pilot channels transmitted by the base station 105 and/or the femtocell 115(1). The results of the inter-RAT channel quality measurements may also be periodically reported to the macrocell 110(3). The macrocell 110(3) can use the reported location/distance and, if available, channel quality information to determine whether the distance 130 is below a distance threshold for triggering a handover to the femtocell 115(1).

The wireless communication system 100 initiates an inter-RAT handoff of the mobile unit 120 from the 2G base transceiver station 105 and corresponding macrocell 110(3) to the 3G femtocell 115(1) when the distance 130 falls below the distance threshold. As part of the handover process, a wireless communication link 135 between the mobile unit 120 and the premier femtocell 115(1) may be created (using the appropriate standards and/or protocols) and the mobile unit 120 may be handed off (as indicated by the dashed line 140) to the premier femtocell 115(1). In one embodiment, the wireless communication system 100 may also use other criteria, such as measures of the quality of the wireless communication link 135, to determine when to perform a handoff. In the illustrated embodiment, the location-based handoff is only applied to premier femtocells 115(1) associated with the mobile unit 120. Accordingly, the mobile unit 120 may be preferentially handed off to its premier femtocell 115(1) even though the air interface 125 to the macrocell 110(3) may be providing sufficiently high quality channel conditions or even channel conditions that are superior to the channel conditions supported by the air interface 135.

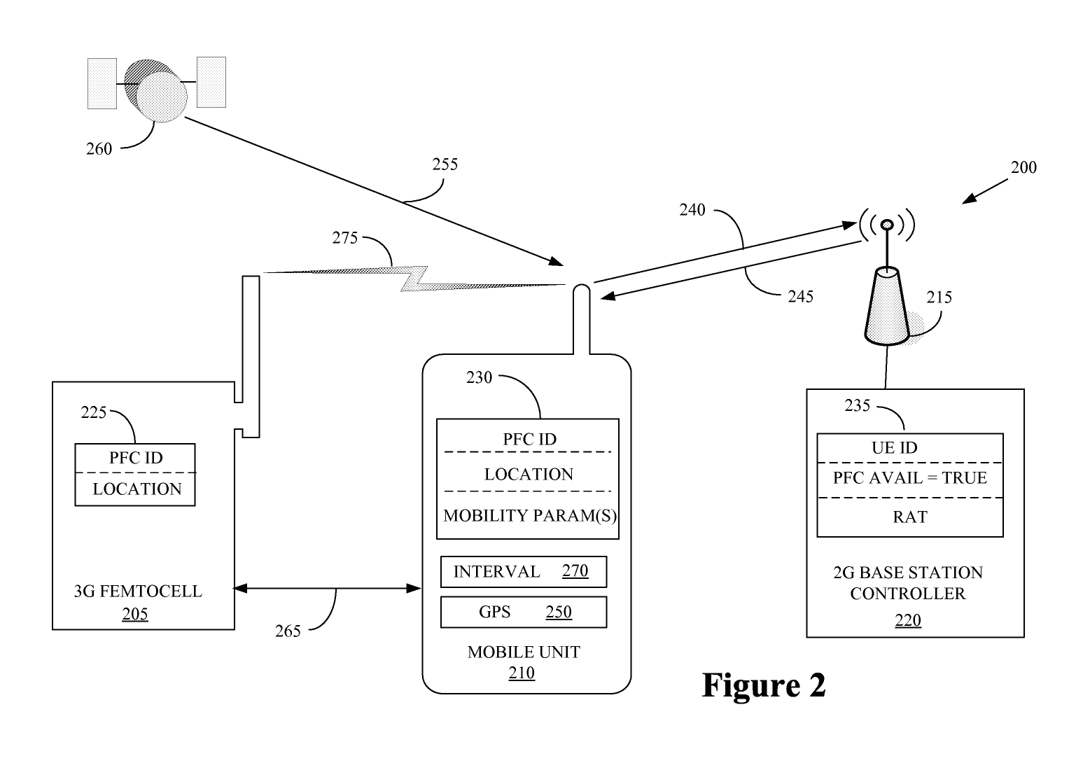

FIG. 2 conceptually illustrates a second exemplary embodiment of a wireless communication system 200. In the illustrated embodiment, the wireless communication system 200 includes a 3G femtocell 205, mobile unit 210, a 2G base transceiver station 215, and a 2G base station controller (BSC) 220. Persons of ordinary skill in the art having benefit of the present disclosure should appreciate that the wireless communication system 200 may include other elements that are not depicted in FIG. 2 to avoid unnecessarily obscuring the discussion. The femtocell 205 is a premier femtocell for the mobile unit 210 and it operates according to a first set of standards and/or protocols, such as a Third Generation femtocell standard for a distributed architecture. In the illustrated embodiment, the femtocell 205 stores information 225 including a femtocell identifier and information indicating the location of the femtocell 205. The location information may be determined using numerous different techniques, including Global Positioning System (GPS) functionality incorporated into the femtocell 205 or manual configuration of the femtocell 205 by a user or a service provider. The base transceiver station 215 operates according to a second set of standards and/or protocols that differs from the first set of standards and/or protocols. For example, the base transceiver station 215 may operate according to a Second Generation standard.

The mobile unit 210 has been configured so that it recognizes the femtocell 205 as its premier femtocell. In the illustrated embodiment, the mobile unit 210 stores the identity of the premier femtocell 205, the location of the premier femtocell 205, and any other mobility parameters associated with the premier femtocell 205. Exemplary mobility parameters include, but are not limited to, primary scrambling codes (PSC), an international mobile subscriber identity (IMSI), a mobile identifier number (MIN), a UTRAN Radio Network Temporary Identifier (U-RNTI), and the like. In the illustrated embodiment, the mobile unit 210 defines a local variable, e.g. a data structure 230, to store the femtocell information relevant to mobility. In the illustrated embodiment, the mobile unit 210 stores the current cell information (relevant to mobility) and the location information (which may be provided by the femtocell 205 in a Connection Setup message) into the PremierFemtoCell local data structure 230 when a PremierFemtoCellAvailable Boolean value in the setup message from the femtocell 205 is set to TRUE.

The base station controller 220 maintains a context database 235 that stores context information associated with the mobile unit 210, as well as other user equipment and/or mobile units served by macrocells that are connected to the base station controller 220. In the illustrated embodiment, the base station controller 220 stores the information associated with the mobile unit 210 and information indicating that the mobile unit 210 is associated with a premier femtocell in the context 235 for the mobile unit 210. For example, the context 235 for the mobile unit 210 may include an identifier, a Boolean variable indicating that a premier femtocell is available, a parameter indicating the frequency used by the premier femtocell 205, and the location of the femtocell 205. Once the context 235 for the mobile unit 210 has been configured, the base station controller 220 knows that the mobile unit 210 is associated with a premier femtocell. Although the mobile unit 210 has been depicted as being associated with a single premier femtocell, persons of ordinary skill in the art having benefit of the present disclosure should appreciate that in alternative embodiments the mobile unit 210 may be associated with more than one premier femtocell.

In the illustrated embodiment, the mobile unit 210 is initially served by the base station 215 over a wireless communication link including an uplink 240 and a downlink 245 that are established according to the second set of standards and/or protocols. The mobile unit 210 is also aware of its location. In the illustrated embodiment, the mobile unit 210 includes Global Positioning System (GPS) functionality 250 to determine its location using signals 255 provided by a network of GPS satellites 260 (only one shown in FIG. 2). Alternatively, the mobile unit 210 can be made aware of its location using information provided by the base station 215 over the downlink 245. This approach can be referred to as an assisted-GPS technique. The mobile unit 210 can therefore use the stored location of the premier femtocell 205 to determine how far away the premier femtocell 205 is from the mobile unit 210.

The base station controller 220 can configure the mobile unit 210 for periodic location measurement and reporting. If the base station controller 220 and the mobile unit 210 implement periodic reporting, the mobile unit 210 is configured to periodically determine its location and/or a distance 265 between the femtocell 205 and the mobile unit 210 by comparing its current location to the stored location of the femtocell 205. The time interval 270 for the periodic measurement/reporting is stored in the mobile unit 210. The time interval 270 may be preconfigured, may be manually entered by a user, or it may be provided to the mobile unit 210 by the base station controller 220 as part of the configuration process. The base station controller 220 may then use the periodically reported values of the distance 265 to determine whether to hand off the mobile unit 210 to the femtocell 205.

The base station controller 220 may also use other information, such as channel conditions if they are available, to determine whether to perform the inter-RAT hand off of the mobile unit 210 to the femtocell 205. In one embodiment, if the radio access technologies implement techniques for performing channel condition or signal strength quality measurements on the target access technology in an inter-RAT handover, the channel conditions may be periodically measured and the values of the measured channel conditions or signal strength qualities periodically reported to the base station controller 220 in response to requests provided by the base station controller 220. For example, in the case of an inter-RAT handover, the base station controller 220 may instruct the mobile unit 210 to perform and report the channel condition or signal strength quality measurements when the base station controller 220 determines that the distance 265 reported periodically by the mobile unit 210 has fallen below a threshold value. One example of a technique that is used in UMTS technologies is a compressed mode technique that allows mobile units to perform inter-RAT channel condition or signal strength quality measurements during specified time intervals. However, other radio access technologies such as 2G GSM do not implement techniques for performing channel condition or signal strength quality measurements on the target access technology in an inter-RAT handover. For example, some radio access technologies implement blind handovers for inter-RAT handover.

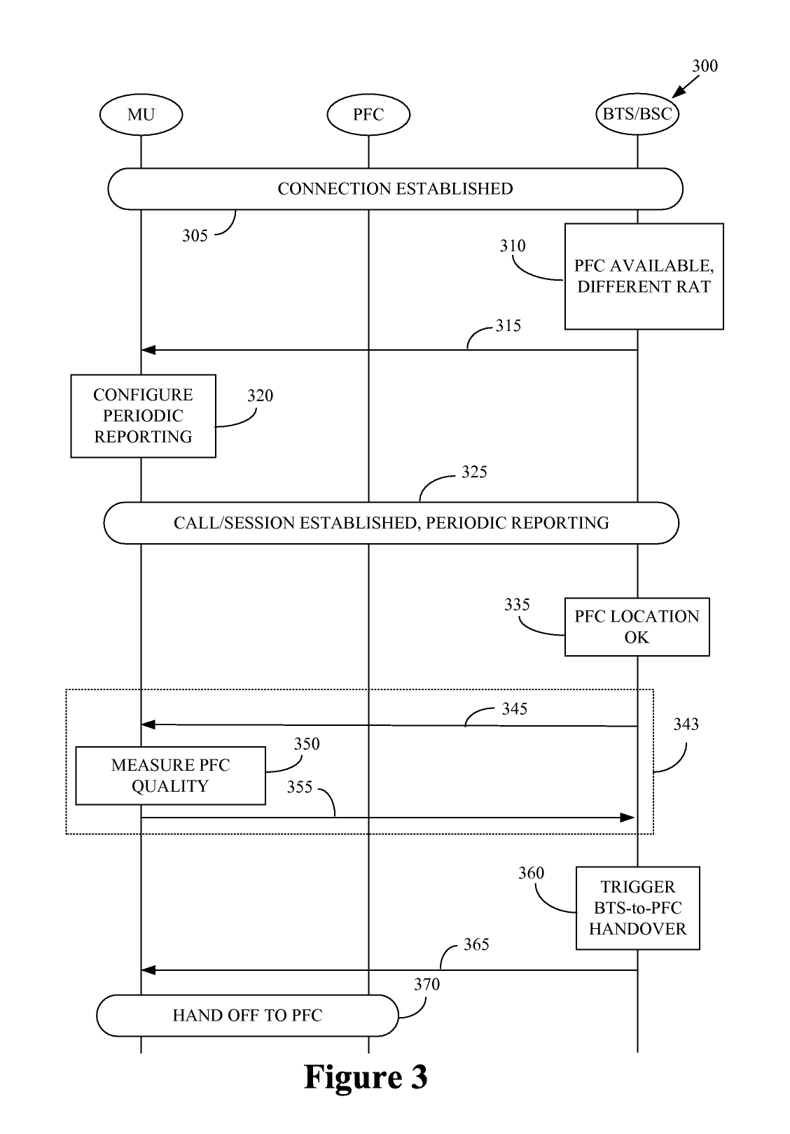

FIG. 3 conceptually illustrates one exemplary embodiment of a method 300 of handing off a mobile unit (MU) from a macrocell (BTS/BSC) to a premier femtocell (PFC) using periodic measurement reporting. In the second exemplary embodiment, the macrocell and the premier femtocell use different radio access technologies for communications over the air interface. The second exemplary embodiment therefore depicts an inter-RAT handoff, e.g. 2G or GSM to UMTS WCDMA. Initially, a connection is established (at 305) between the mobile unit and the macrocell. The macrocell then determines (at 310) whether the mobile unit has an associated premier femtocell. For example, the macrocell may examine the context associated with the mobile unit to determine (at 310) whether the variable PremierFemtoCellAvailable is set to TRUE. In the illustrated embodiment, the mobile unit does have an associated premier femtocell, so the macrocell may determine (at 310) the radio access technology used by the premier femtocell to communicate with the mobile unit, which in the second exemplary embodiment may be the same or different than the radio access technology of the macrocell.

The macrocell then initiates (at 315) the configuration of periodic reporting of the distance between the mobile unit and the premier femtocell. The mobile unit receives this information and configures (at 320) the periodic location/distance reporting. For example, the mobile unit may receive (at 320) information indicating a time interval that should be used to periodically measure and report the distance between the mobile unit and the premier femtocell. Alternatively, the time interval may be preconfigured or manually entered by a user. Configuration (at 320) of the mobile unit may also include defining the fields and/or parameters of messages that are periodically transmitted to the macrocell. For example, the mobile unit may be configured (at 320) to transmit Measurement Reports that include information indicating the distance between the mobile unit in the femtocell.

A call and/or session may then be established (at 325) between the mobile unit and the macrocell. At this point in the process, the call between the mobile unit and the macrocell can proceed. Since the mobile unit has been configured (at 320) for periodic reporting of the location information, the mobile unit continues to compare (concurrently with other call processes) its location to the location of its premier femtocell. For example, the mobile unit can compare (at 335) the current location of the mobile unit to a location of the premier femtocell to determine the distance:

UE_PremierFemto_distance=UE_coordinates−premierFemto_coordinates.

The mobile unit periodically reports the measured distance to the macrocell/radio network controller by transmitting messages, such as Measurement Report messages, at the configured time interval.

In the illustrated embodiment, the BSC can determine (at 335) whether the distance between the mobile unit and the premier femtocell is small enough to trigger an inter-RAT or inter-system handoff from the macrocell to the premier femtocell. For example, the periodically reported distance can be compared to a threshold value and a handoff procedure may be desirable if:

UE_PremierFemto_distance<MacroToFemtoDistanceThreshold

In one embodiment, the base station controller (BSC) triggers (at 360) the inter-RAT handover of the mobile unit from the macrocell to the femtocell when the distance criterion is satisfied, i.e., the periodically reported distance falls below the distance threshold. For example, the base station controller (BSC) can send (at 365) a request to initiate the inter-RAT handover to the mobile unit. The mobile unit can then perform (at 370) an inter-RAT handover from the macrocell to the premier femtocell.

As discussed herein, different radio access technologies may or may not support inter-RAT signal strength quality measurements. If the radio access technologies involved in the handover depicted in FIG. 3 support inter-RAT signal strength quality measurements, then the information gathered using these measurements can be used to decide whether to perform (at 370) the inter-RAT handover from the macrocell to the premier femtocell. The method 300 may then include the additional steps depicted in the box 343. In the illustrated embodiment, the macrocell responds (at 345) to the periodic measurement reports by transmitting a message indicating that the mobile unit should perform measurements of the signal strength quality between the mobile unit and the premier femtocell. One exemplary technique for allowing the mobile unit to perform inter-RAT signal strength quality measurements is the compressed mode implemented UTMS systems. However, other techniques may also be used to support measurement of the signal strength quality between the mobile unit and the premier femtocell.

When the mobile unit receives this message, the mobile unit measures (at 350) the signal strength quality, e.g., a signal-to-noise ratio or a received signal channel power that is measured using a pilot channel transmitted by the femtocell. Information indicating the measured signal strength quality can then be reported (at 355) to the base station controller. The inter-RAT measurements are reported periodically. When the mobile periodically reports (at 355) the results of the inter-RAT measurements then the base station controller (BSC) can use the information included in the measurement reports to trigger (at 360) the inter-RAT handover of the mobile unit from the macrocell to the femtocell when the signal strength quality of the channel between the mobile unit and the femtocell is sufficiently high to support communication over the air interface providing that the distance based criteria is still met i.e. UE_PremierFemto_distance<MacroToFemtoDistanceThreshold. In various alternative embodiments, the measurement report may also include other mobility information including, but not limited to, primary scrambling codes, timing and/or offset information, measures of the signal strength quality, and the like.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for implementation in a mobile unit that is configured to communicate with a wireless communication system that comprises at least one macrocell and at least one femtocell, said at least one macrocell using a different radio access technology than said at least one femtocell, the method comprising:
periodically reporting, from the mobile unit to the macrocell, a distance between said mobile unit and said at least one femtocell; and
performing an inter-radio access technology handoff of the mobile unit from said at least one macrocell to said at least one femtocell when said distance is less than a threshold distance.

2. The method of claim 1, comprising periodically determining, at said mobile unit, a distance between said mobile unit and said at least one femtocell at a selected time interval.

3. The method of claim 2, wherein periodically reporting the distance comprises periodically transmitting, from said mobile unit to said at least one macrocell, first measurement reports at a selected time interval, wherein said first measurement reports comprise information indicating the distance between said mobile unit and said at least one femtocell.

4. The method of claim 3, comprising configuring the selected time interval based on at least one of a time interval provided by the macrocell, a pre-configured time interval, or a user-configured time interval

5. The method of claim 1, comprising receiving instructions to measure at least one signal strength quality for communication between said mobile unit and the femtocell when the distance is less than the threshold distance.

6. The method of claim 5, wherein measuring said at least one signal strength quality comprises measuring at least one of a signal-to-noise ratio or a received signal channel power using a pilot channel transmitted by said at least one femtocell.

7. The method of claim 6, comprising transmitting information indicating at least one measured value of the signal-to-noise ratio or the received signal channel power.

8. The method of claim 7, wherein performing the inter-radio access technology handoff comprises receiving, at the mobile unit, a request to hand off from said at least one macrocell to said at least one femtocell when said at least one measured value of the signal-to-noise ratio or the received signal channel power is more than a corresponding threshold value of said signal-to-noise ratio or received signal channel power.

9. The method of claim 8, wherein performing the inter-radio access technology handoff comprises handing off said mobile unit from said at least one macrocell to said at least one femtocell in response to receiving the request to hand off.

10. The method of claim 1, comprising identifying said at least one femtocell as at least one premier femtocell associated with said mobile unit.

11. The method of claim 10, wherein identifying said at least one femtocell as at least one premier femtocell comprises:
providing a call connection request from said mobile unit to said at least one femtocell;
receiving, at said mobile unit from said at least one femtocell in response to providing the call connection request, information indicating a location of said at least one femtocell and information indicating that said at least one femtocell is a premier femtocell associated with said mobile unit; and
storing the information indicating the location of the premier femtocell in said mobile unit.

12. A method for implementation in a wireless communication system that comprises at least one macrocell and at least one femtocell, said at least one macrocell using a different radio access technology than said at least one femtocell, the method comprising:
periodically receiving, at the macrocell from the mobile unit, information indicating a distance between said mobile unit and said at least one femtocell; and
performing an inter-radio access technology handoff of the mobile unit from said at least one macrocell to said at least one femtocell when said distance is less than a threshold distance.

13. The method of claim 12, comprising:
periodically receiving, from said mobile unit, first measurement reports at a selected time interval, wherein said first measurement reports comprise information indicating the distance between said mobile unit and said at least one femtocell.

14. The method of claim 13, comprising providing instructions to perform signal strength quality measurements for communication between said mobile unit and the femtocell when the distance is less than the threshold distance.

15. The method of claim 14, comprising receiving, from said mobile unit in response to the instructions to perform signal strength quality measurements, information indicating at least one measured value of the signal-to-noise ratio or the received signal channel power.

16. The method of claim 15, wherein performing the inter-radio access technology handoff comprises providing a request to hand off from said at least one macrocell to said at least one femtocell when said at least one measured value of the signal-to-noise ratio or the received signal channel power is more than a corresponding threshold value of said signal-to-noise ratio or received signal channel power.

17. The method of claim 12, comprising identifying said at least one femtocell as at least one premier femtocell associated with said mobile unit.
